(19) United States
(12) Patent Application Publication
(10) Pub. No.: US 2026/0044361 A1
(43) Pub. Date: Feb. 12, 2026

(54) AUTOMATIC RECOVERY OF VIRTUAL MACHINES

(71) Applicant: INTERNATIONAL BUSINESS MACHINES CORPORATION, ARMONK, NY (US)

(72) Inventors: Imranuddin Wakaruddin Kazi, Hyderabad (IN); Joseph W. Cropper, Round Rock, TX (US); Brian Frank Veale, Cedar Park, TX (US); Sharat Sharma S, Hyderabad (IN)

(21) Appl. No.: 18/800,075

(22) Filed: Aug. 11, 2024

(51) Int. Cl. G06F 9/455

(52) U.S. Cl. CPC G06F 9/45558; G06F 2009/45575; G06F 2009/45591; G06F 2009/45595

(57) ABSTRACT

A method and system for managing servers by obtaining a configuration of a plurality of server groups, the configuration including information about virtual machines on servers of the server groups, and the plurality of server groups including at least one pool of standby servers that is at least operatively distinct from a rest of the plurality of server groups. The method further includes detecting a failure event of a failed server, automatically allocating, a standby server of the at least one pool of standby servers to a server group of the failed server based on a server priority value of the failed server and/or a virtual machine priority value of one or more virtual machines of the failed server, and remotely restarting the one or more virtual machines of the failed server on the standby server.

### BACKGROUND

### Technical Field

The present disclosure generally relates to data processing environments, and more particularly, to automatic recovery of virtual machines.

### Description of the Related Art

Cloud computing has offered a shift from traditional on-premises data centers to distributed, scalable, and flexible computing resources accessed over the internet. This evolution has been driven by the increasing demand for more efficient, cost-effective, and reliable IT infrastructure and services.

In some implementations, cloud computing can provide virtualized computing resources over the internet where users may rent virtual machines (VMs), storage, and networks, enabling the execution of user-specific applications. In other implementations, cloud computing may offer a platform that allows customers to develop, run, and manage applications without dealing with the complexity of the underlying infrastructure.

### BRIEF SUMMARY

According to an embodiment of the present disclosure, a method includes obtaining a configuration of a plurality of server groups, the configuration including information about virtual machines on servers of the server groups, and the plurality of server groups including at least one pool of standby servers that is at least operatively distinct from a rest of the plurality of server groups. The method further includes detecting a failure event of a failed server, automatically allocating, a standby server of the at least one pool of standby servers to a server group of the failed server, based on at least one priority value selected from the group consisting of a server priority value of the failed server and a virtual machine priority value of one or more virtual machines of the failed server, and remotely restarting the one or more virtual machines of the failed server on the standby server.

In one embodiment, a method includes assigning, to each of the one or more virtual machines of servers of the server groups, the virtual machine priority value prior to the detecting, and assigning, to each of the servers of the server groups, the server priority value prior to the detecting.

In one embodiment, a method includes generating the server priority value using at least one of the following factors: information about a user of the one or more virtual machines of the server, a workload of the one or more virtual machines of the server, a number of the one or more virtual machines on the server, a tenancy type of the server group of the server, and a server type of the server.

According to an embodiment of the present disclosure, a system includes a plurality of server groups each server group including one or more servers. The system also includes a processor and a memory in communication with the processor, with one or more computer program instructions stored on the memory. The computer program instructions, when executed by the processor, cause the processor to perform one or more operations, including obtaining a configuration of the plurality of server groups, the configuration including information about virtual machines on servers of the server groups, and the plurality of server groups including at least one pool of standby servers that is at least operatively distinct from a rest of the plurality of server groups. The operations further include detecting a failure event of a failed server, automatically allocating, responsive to the detecting, a standby server of the at least one pool of standby servers to a server group of the failed server, based on at least one priority value selected from the group consisting of a server priority value of the failed server and a virtual machine priority value of one or more virtual machines of the failed server, and remotely restarting the one or more virtual machines of the failed server on the standby server.

According to an embodiment of the present disclosure, a computer program product for managing servers includes one or more computer-readable storage devices and program instructions stored on the at least one of the one or more computer-readable storage devices, the program instructions executable by a processor, the program instructions including program instructions to obtain a configuration of a plurality of server groups, the configuration including information about virtual machines on servers of the server groups, and the plurality of server groups including at least one pool of standby servers that is at least operatively distinct from a rest of the plurality of server groups. The program instructions further include program instructions to detect a failure event of a failed server, program instructions to automatically allocate, responsive to the detecting, a standby server of the at least one pool of standby servers to a server group of the failed server based on at least one priority value selected from the group consisting of a server priority value of the failed server and a virtual machine priority value of one or more virtual machines of the failed server, and program instructions to remotely restart the one or more virtual machines of the failed server on the standby server.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of a network of data processing systems in accordance with an illustrative embodiment.

FIG. 2 depicts a block diagram of a computing environment in accordance with an illustrative embodiment.

FIG. 3 depicts an architecture of a recovery engine in accordance with an illustrative embodiment.

FIG. 4 depicts a plurality of server groups in accordance with an illustrative embodiment.

FIG. 5 depicts failed servers of a plurality of server groups in accordance with an illustrative embodiment.

FIG. 6 depicts allocation of standby servers in accordance with an illustrative embodiment.

FIG. 7 depicts the roaming of standby servers in accordance with an illustrative embodiment.

FIG. 8 depicts a routine for managing servers in accordance with one embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

It is recognized that as data centers continue to grow in capacity, it may be a challenge to provide both multi-tenant and dedicated host options for users as data centers with a potentially large number of compute nodes can experience hardware failure at any moment, interrupting clients'workloads. Accordingly, it may be increasingly useful to prioritize making providing reliable systems to users especially as mission critical enterprise workloads become more common.

By way of example and not by way of limitation, a data center may comprise hundreds of power servers. In a server failure event where all or most of the power servers are down, it may be impractical to have a corresponding number of standby servers readily available to take over the activities of the failed power servers. Further, an importance score of customers of the data center may vary. It is recognized that by identifying virtual machines associated with higher importance scores, failure events may be mitigated, at least to an extent, by adopting a prioritized virtual machine restart procedure.

Embodiments of the present disclosure generally relate to a method for managing servers by obtaining a configuration of each of a plurality of server groups, the configuration including information about virtual machines on servers of the server groups. The plurality of server groups including at least one pool of standby servers that is at least operatively distinct from a rest of the plurality of server groups. Responsive to detecting a failure event, a standby server from the at least one pool of standby servers is automatically allocated to a server group of the failed server based on at least one priority value selected from the group consisting of a server priority value of the failed server and a virtual machine priority value of one or more virtual machines of the failed server. The one or more virtual machines of the failed server are then remotely restarted on the standby server.

Overall, embodiments offer the automatic recovery of virtual machines of failed hosts wherein an importance of workloads and users are considered.

In one embodiment, certain operations are described as occurring at a certain component or location. Such locality of operations is not intended to be limiting on the illustrative embodiments. Any operation described herein as occurring at or performed by a particular component, can be implemented in such a manner that one component-specific function causes an operation to occur or be performed at another component, e.g., at a local or remote engine, respectively. In one aspect, the method described herein, is implemented to execute on a particularly configured computing device or data processing system and provides substantial advancement of the functionality of that computing device or data processing system. Embodiments thus have the capacity to improve the technical field of analyzing query performances using a database monitoring system.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably processed manually by a human user.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures, therefore, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

### Example Data Processing Environment

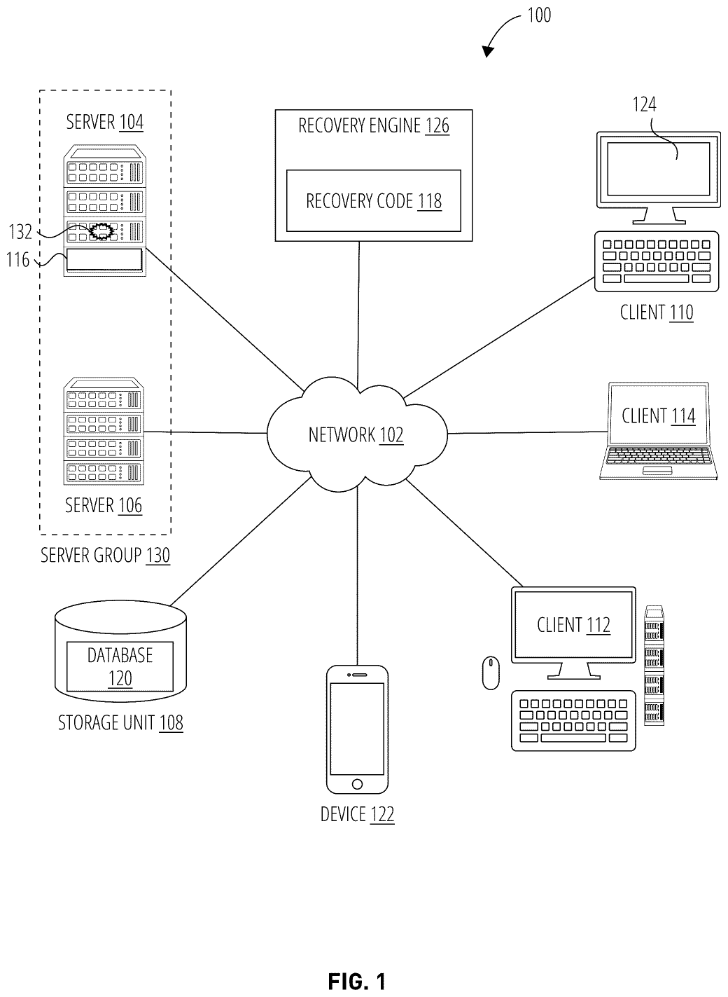

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), recovery engine 126, and device 122, may include data and may have software applications or software tools executing thereon. Server 104 and server 106 may be a part of a plurality of server groups 130 including at least one pool of standby servers. Server 104 and server 106 may further include configuration that provides information about virtual machines 132 on the servers.

Only as an example, and without implying any limitation to such architecture, FIG. 1 depicts certain components that are usable in an example implementation of an embodiment. Data processing systems (recovery engine 126, server 104, server 106, client 110, client 112, client 114, and device 122) also represent example nodes in a cluster, partitions, and other configurations suitable for implementing an embodiment.

Server 104, server 106, storage unit 108, client 110, client 112, client 114, device 122, recovery engine 126 may couple to network 102 using wired connections, wireless communication protocols, or other suitable data connectivity. Client 110, client 112 and client 114 may be, for example, personal computers or network computers. Any of the clients may include a client application 124.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Recovery engine 126 may also be a part or separate from server 104 or server 106. Server application 116, and/or recovery engine 126 may include recovery code 118 configured for automatic recovery of virtual machines 132.

Device 122 is an example of a device described herein. For example, device 122 can take the form of a smartphone, a tablet computer, a laptop computer, client 110 in a stationary or a portable form, or any other suitable device. Database 120 of storage unit 108 may store one or more information for operations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as recovery code 118. In addition to the recovery code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and the recovery code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

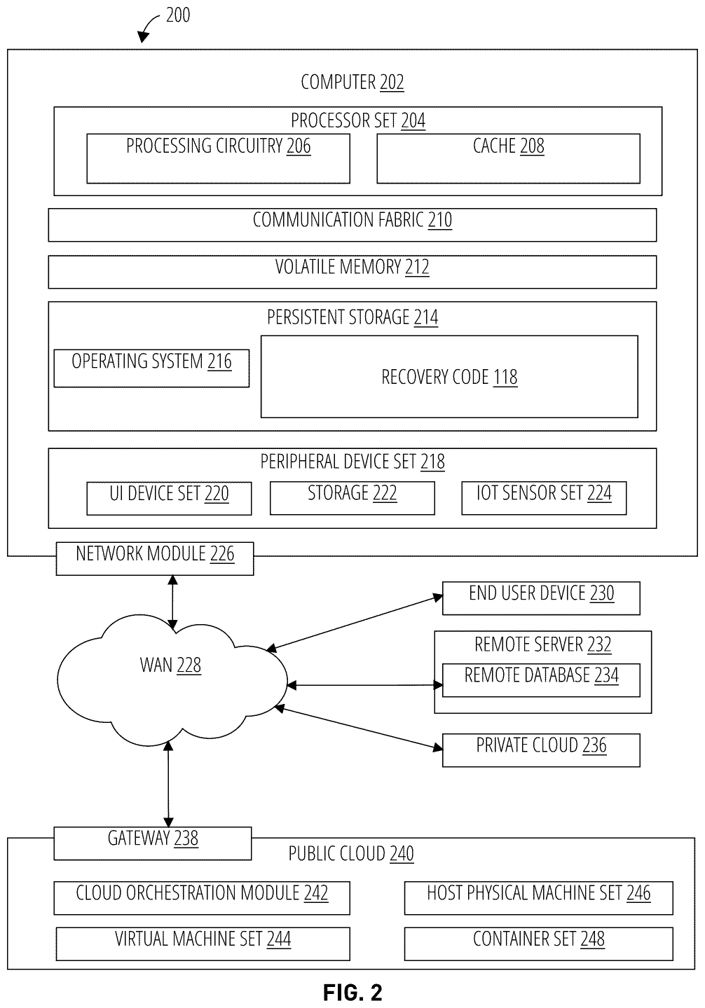

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip. ” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in the recovery code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214 may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in the recovery code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer, and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

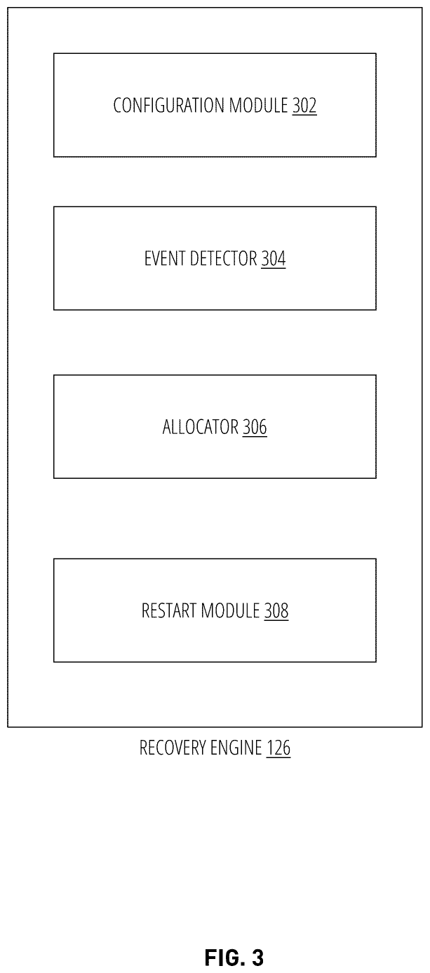

Reference is now made to FIG. 3 which illustrates an architecture of a recovery engine 126 in accordance with one or more embodiments. The recovery engine 126 may be operated based on recovery code 118 to perform automatic recovery of virtual machines as discussed herein. The recovery engine 126 comprises a configuration module 302, an event detector 304, an allocator 306, and a restart module 308.

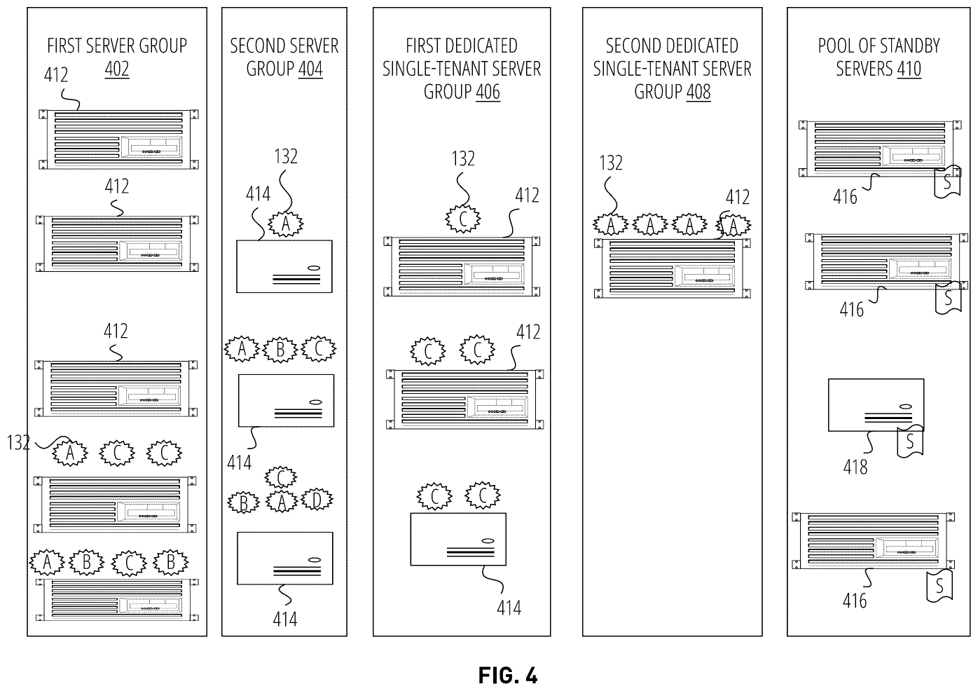

The configuration module 302 may obtain a configuration of each server group 130, the configuration including information about virtual machines 132 on servers 104, 106 of the server group 130. The server groups 130 may represent servers of the same structure (e.g., capacity, capabilities, etc.) or function (e.g., single tenant, multi-tenant, etc.). However, the server groups can also be of different types but same function-e.g., a dedicated single tenant group. At least one server group of a plurality of server groups may be a pool of standby servers that is at least operatively distinct from the rest server groups. More specifically, as shown in FIG. 4, servers of a pool of standby servers 410 may be reserved for use when an existing server fails.

The event detector 304 detects a failure event of a failed server. The failure event may comprise the loss of a server 104 or potential loss of the server 104 or any event of a server or virtual machine that meets a predetermined failure criterion, such as the shutting down of the server 104, loss of power for the server 104, inadequate memory available on the server or any other event that causes the loss or potential loss of a virtual machine 132 of the server 104.

Upon detecting the failure event, which may be a plurality of failure events, the allocator 306 may automatically allocate, one or more standby servers of the at least one pool of standby servers 410 to one or more failed servers based on server priority values of the one or more failed servers and/or virtual machine priority values of one or more virtual machines 132 of the one or more failed servers as discussed hereinafter. The restart module 308 subsequently restarts the one or more virtual machines 132 on the allocated one or more standby servers.

FIG. 4 illustrates a plurality of server groups 130 wherein the recovery engine 126 manages servers 104 of the plurality of server groups 130 according to techniques described herein.

The plurality of server groups 130 comprise a first server group 402, a second server group 404, a first dedicated single-tenant server group 406, a second dedicated single-tenant server group 408, a pool of standby servers 410. Servers of the plurality of server groups may be of a plurality of different types and structures such as a first server type 412, a second server type 414, a standby server of first type 416, and a standby server of second type 418. The type of server may be selected based one or more server property criteria such as a processor, core and speed, a use criterion, a memory capacity criterion, a power supply criterion.

In the example of FIG. 4, the first server group 402 includes five of the first server types 412. The second server group 404 includes three of the second server types 414. The first dedicated single-tenant server group 406 may be provisioned for use by a single tenant (user) and may include two of the first server types 412 and one of the second server types 414. Likewise, the second dedicated single-tenant server group 408 may also be provisioned for use by a single tenant (user) and may include one of the first server types 412. The pool of standby servers 410 may include a plurality of standby servers as depicted by the letter “S” for illustration purposes. The plurality of standby servers S may include three of the standby servers of first type 416 and one of standby servers of second type 418.

Unlike the standby servers S, the remaining servers may host one or more virtual machines 132. For illustration purposes, the virtual machines are depicted as A, B, C, or D to depict a use for which the virtual machine is provisioned.

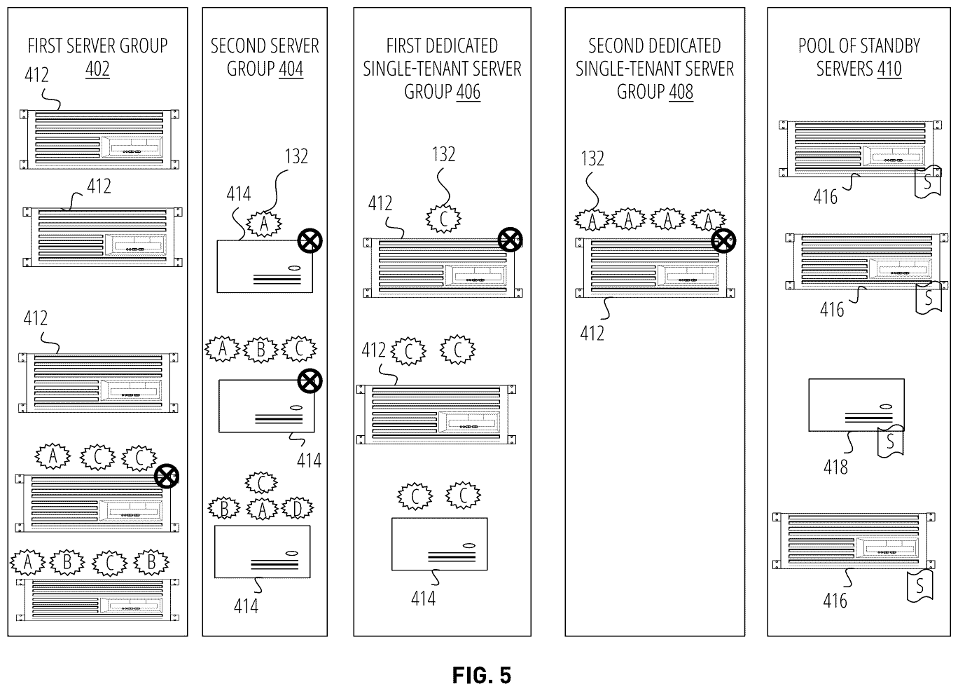

As shown in FIG. 5, one or more of the servers 104 of FIG. 4 may fail for a number of reasons. The failed servers are depicted by the letter X for illustration purposes. The first server group 402 has one failed server with three virtual machines depicted as A, C, and C deployed thereon, signifying two different users A, and C. The second server group 404 has two failed servers with one virtual machine depicted as A deployed on the first failed server and virtual machines depicted as A, B, and C deployed on the second failed server. The first dedicated single-tenant server group 406 has one failed server with one virtual machine depicted as C deployed thereon, and the second dedicated single-tenant server group 408 has one failed server with four virtual machines depicted as A, A, A, and A deployed thereon.

Upon detecting the failed servers X, the recovery engine 126 uses information about the configuration of the server groups 130 including information about the virtual machines running on servers of the server groups to determine how to allocate the standby servers S. A goal may be not only be to automatically allocate the standby servers S, but to also automatically restart virtual machines 132 of the failed servers X on the standby servers S in in a prioritized manner. The standby servers may be operated such that there are no virtual machines 132 operating thereon prior to being allocated. Thus, before being allocated, the standby designation may be enforced to prevent the deployment of virtual machines 132 on the standby server.

Even further, a check may be conducted to confirm the absence of virtual machines 132 on the standby server S prior to allocation. Upon allocation, the standby designation of the server may be removed such that the standby server S is no longer on standby and virtual machines 132 can be deployed and operate thereon. Further, restarting virtual machines may be performed based on a priority policy that favors important users.

As shown in the example of FIG. 5, even though there are five failed servers, there are four available standby servers. As discussed herein, the recovery engine 126 may generate a priority value for the servers 104 including at least the failed servers. A priority value may also be generated for the virtual machine 132. In one embodiment, the priority value of a server 104 depends on the priority values of the virtual machines 132 present on the server 104. Generating the priority values may be performed before a failure event, or on demand such as in some rare cases even after a failure event is detected. More specifically, the recovery engine 126 may assign to one or more virtual machines 132 of servers 104 of the server groups 130, a virtual machine priority value, and assign, to one or more servers 104 of the server groups 130, a server priority value. The server priority value may be generated on the virtual machine priority values. More specifically, the server priority value may be generated based on information about the one or more virtual machines 132 of the server, the information including, for example, information about a user or about an importance score of the user of the virtual machine and information about applications running on the virtual machine 132 such as information about a workload of the virtual machine 132. Of course, other factors may be used to generate the server priority value such as the number of virtual machines on the server, the tenancy type of the server group and the server type of the server. In an embodiment, the assigning of server priority values and/or virtual machine priority values may be performed or retrieved on the basis of failed servers, to save time.

In the illustration of FIG. 5, the recovery engine 126 may assign a server priority value of, for example, “HIGH” to the failed servers of first server group 402, first dedicated single-tenant server group 406 and second dedicated single-tenant server group 408. For the second server group 404, the recovery engine 126 may assign a server priority value of “HIGH” to the failed server on which three virtual machines A, B, and C were deployed, and a server priority value of “LOW” to the failed server on which one virtual machine A was deployed. This assignment may be because of the comparatively smaller workload. In an embodiment, comparison of server priority values to determine allocation of standby servers can be limited to server groups 130. In another embodiment, comparison of server priority values to determine which failed servers may receive an allocation of standby servers may take into consideration other server groups such as the tenancy type of other server groups. For example, since servers of a single tenant server group may include virtual machines of a single user, the importance score of that single user and/or the number of virtual machines on the failed server of that single user may be taken into consideration to weight or rank the failed server against other failed servers of other server groups. Of course, the priority values need not be binary and can alternatively take on any a plurality of values in a range such as a score from 1-10 or a percentage between 0% and 100%. Further, the server priority values can be generated based on virtual machine priority values for the virtual machines.

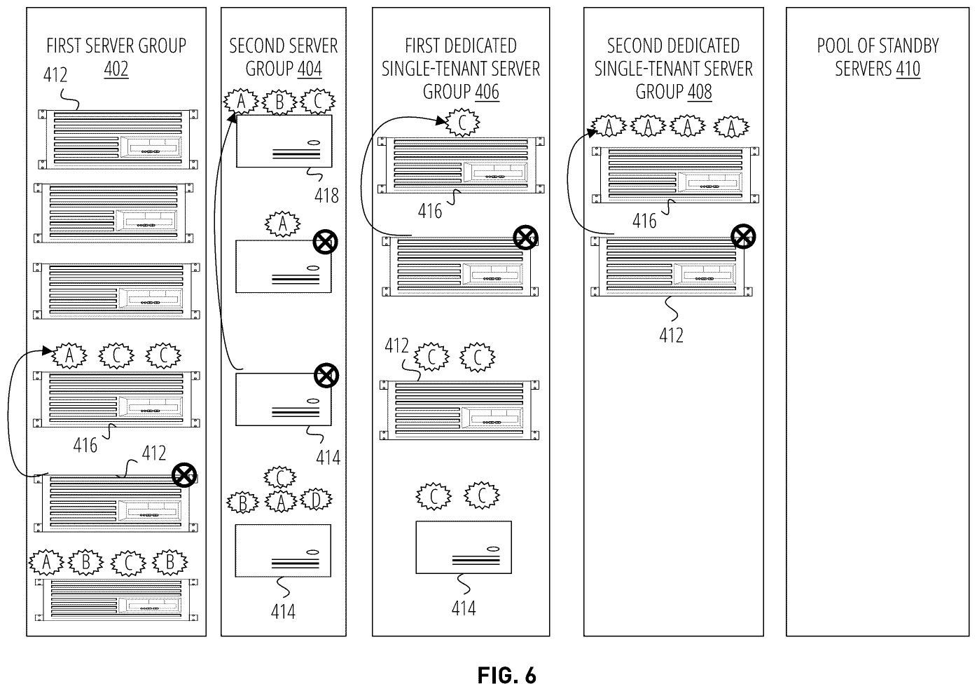

As shown in FIG. 6, the recovery engine 126 then automatically allocates the standby servers of the pool of standby servers 410 to the four failed servers designated to have a “HIGH” server priority value. In an embodiment, the allocation can be performed responsive to performing a viability action to compute a viability of the standby server S to replace the failed server X. The viability may include an ability of a standby server S to host the virtual machines of the failed server X, a check to verify that the standby server S is of a same type as the failed server, or any other predetermined viability criteria.

Further, the virtual machines of the failed server may be remotely restarted on the allocated server according to an order for remotely restarting the virtual machines. The order can be based on the virtual machine priority values such that virtual machines corresponding to users with higher importance scores based on predetermined criteria are restarted before virtual machines corresponding to users with comparatively lower importance score, or such that virtual machines with comparatively higher workloads are restarted before virtual machines with comparatively lower workloads. The importance score may be determined by the value of the user such as a total client value (TCV) of the user, a spending power of the user, a risk assessment of the user, or otherwise any factors that can determine an importance of the user to an owner of the data center. As is shown in FIG. 6, due to the limited number of available standby servers S, no standby server S is allocated to the failed server X of the second server group 404 on which one virtual machine A was deployed. Thus, the allocation of standby servers can be generally based on at least one of these factors: the user of the virtual machines of the server such as the value of the user to an owner of the data canter, the workload of the virtual machines of the server, such as the tasks, processes, and applications that the VM is responsible for executing, the number of virtual machines on the server, the tenancy type of the server group of the server such as a single tenant or multi-tenant designation, and the server type of the server including, for example, servers designed for robust, mission-critical workloads or servers designed for scalability in large-scale computing environments. In some cases where a plurality of the factors is used, the user may be weighted more than the rest of the factors used.

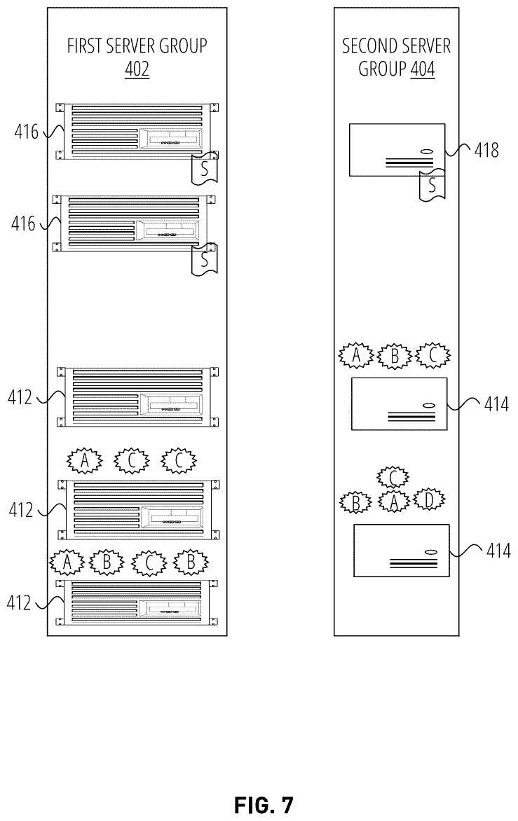

Reference is now made to FIG. 7, which illustrates an embodiment in which standby servers S can be assigned to server groups without removing the standby designation. Upon removing the standby designation, virtual machines may be deployed thereon. Responsive to having no virtual machines on a server, the server may be designated as a standby server S and thus be eligible to be part of a pool of available standby servers that are logically grouped together in one server group 130 or distributed among a plurality of server groups 130. The standby servers can be moved from one server group to another and may have virtual machines deployed thereon only after the standby designation is removed.

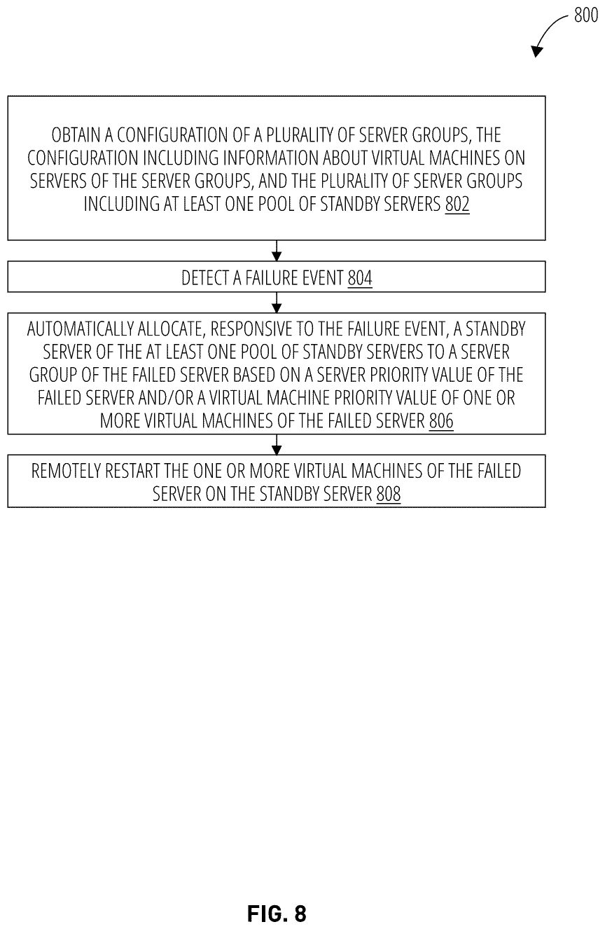

FIG. 8 illustrates a process 800 for automatic recovery of virtual machines in accordance with an illustrative embodiment. The process 800 may be performed with the recovery engine 126.

In block 802, the recovery engine 126 obtains a configuration of a plurality of server groups 130, the configuration including information about virtual machines on servers 104 of the server groups 130, and the plurality of server groups 130 including at least one pool of standby servers 410 that is at least operatively distinct from a rest of the plurality of server groups.

In block 804, recovery engine 126 detects a failure event of a failed server. The failure event may include an actual failure or a prediction of an upcoming failure of the server or virtual machine according to predetermined failure criteria.

In block 806, the recovery engine 126 automatically allocates a standby server S of the at least one pool of standby servers 410 to a server group 130 of the failed server X based on a server priority value of the failed server X and/or a virtual machine priority value of one or more virtual machines of the failed server X.

A plurality of other standby servers can also be allocated to alleviate other failed servers based on other server priority values of the other failed servers X and/or virtual machine priority values of one or more other virtual machines of the other failed servers. In an embodiment, the priority values of all failed servers of a data center may be ranked against each other and the failed servers alleviated with standby servers based on the ranking. In block 808, the recovery engine 126 remotely restarts the one or more virtual machines of the failed server on the allocated standby servers.

In an example, a method is implemented to manage servers by obtaining a configuration of server groups, the configuration including information about virtual machines on servers of the server groups, wherein the plurality of server groups includes at least one pool of standby servers. Upon detecting one or more failure events, one or more standby servers are automatically allocated to the corresponding server groups of the one or more failed servers based on determining the importance of each of the failed servers. The importance is determined by analyzing any combination of factors selected from the group consisting of workloads of virtual machines of the failed servers, user information about the virtual machines, a number of the virtual machines on a failed server, a tenancy type of the server group of the failed server, and a server type of the failed server. When a plurality of these factors is used, some of the factors can be weighted more than others. For example, user “TCV” of a virtual machine can be weighted more than the workload of the virtual machine. Upon determining the importance for at least all of the failed servers, server groups of the failed servers with higher importance are assigned with an available standby server first before the server groups of the remaining servers with relatively lower importance are assigned with any other available standby servers. Further, the virtual machines with higher importance are restarted on the standby servers before virtual machines with comparatively lower importance.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer implemented method of managing servers comprising:
obtaining a configuration of a plurality of server groups, the configuration including information about virtual machines on servers of the plurality of server groups, wherein the plurality of server groups include at least one pool of standby servers that is at least operatively distinct from a rest of the plurality of server groups;
detecting a failure event of a failed server of a server group of the plurality of server groups;
upon detecting the failure event of the failed server of the server group of the plurality of server groups, automatically allocating a standby server of the at least one pool of standby servers to the server group of the failed server based on at least one priority value selected from the group consisting of a server priority value of the failed server and a virtual machine priority value of one or more virtual machines of the failed server; and
remotely restarting the one or more virtual machines of the failed server on the standby server.

2. The computer implemented method of managing servers of claim 1, further comprising:
assigning, to each of the one or more virtual machines of servers of the server groups, the virtual machine priority value prior to the detecting; and
assigning, to each of the servers of the server groups, the server priority value prior to the detecting.

3. The computer implemented method of managing servers of claim 2, further comprising generating the server priority value based at least one factor selected from information about a user of the one or more virtual machines of the server, a workload of the one or more virtual machines of a server, a number of the one or more virtual machines on the server, a tenancy type of the server group of the server, or a server type of the server.

4. The computer implemented method for managing servers of claim 3, wherein the server priority value is generated based a plurality of factors including information about the user, the information about the user being an importance score of the user, and the importance score is weighted more than any other remaining factor used.

5. The computer implemented method for managing servers of claim 2, further comprising generating the virtual machine priority value of a virtual machine of the one or more virtual machines based on at least one factor selected from information about the virtual machine, and a workload of the virtual machine.

6. The computer implemented method for managing servers of claim 1, further comprising computing an order for remotely restarting the one or more virtual machines of the failed server using virtual machine priority values of the one or more virtual machines of the failed server and remotely restarting the one or more virtual machines based on the order.

7. The computer implemented method for managing servers of claim 1, wherein automatically allocating the standby server of the at least one pool of standby servers is responsive to performing a viability action to compute a viability of the standby server to replace the failed server.

8. The computer implemented method for managing servers of claim 1, wherein each of the server groups are configured to have a distinct structure and/or function.

9. The computer implemented method for managing servers of claim 1, further comprising removing a standby designation of the standby server of the at least one pool of standby servers responsive to allocating the standby server, such that the standby server is no longer part of the at least one pool of standby servers.

10. The computer implemented method for managing servers of claim 1, further comprising designating a server of a server group as a standby server responsive to the server having no virtual machines.

11. A computing device comprising:
a processor; and
a memory, in communication with the processor, with one or more computer program instructions stored on the memory, the computer program instructions, when executed by the processor, cause the computing device to perform operations comprising:
obtaining a configuration of a plurality of server groups, each server group including one or more servers, the configuration including information about virtual machines on servers of the plurality of server groups, wherein the plurality of server groups include at least one pool of standby servers that is at least operatively distinct from a rest of the plurality of server groups;
detecting a failure event of a failed server of a server group of the plurality of server groups;
upon detecting the failure event of the failed server of the server group of the plurality of server groups, automatically allocating, a standby server of the at least one pool of standby servers to the server group of the failed server based on at least one priority value selected from the group consisting of a server priority value of the failed server and a virtual machine priority value of one or more virtual machines of the failed server; and
remotely restarting the one or more virtual machines of the failed server on the standby server.

12. The computing device of claim 11, wherein at least one server group of the plurality of server groups is a multi-tenant server group that hosts virtual machines for a plurality of different users.

13. The computing device of claim 11, wherein at least one server group of the plurality of server groups is a single-tenant server group that hosts virtual machines for one user.

14. The computing device of claim 11, wherein the execution of the program instructions by the processor further configures the computing device to perform operations comprising:
assigning, to each of the one or more virtual machines of servers of the server groups, the virtual machine priority value prior to the detecting; and
assigning, to each of the servers of the server groups, the server priority value prior to the detecting.

15. The computing device of claim 14, wherein the execution of the program instructions by the processor further configures the computing device to perform an operation comprising generating the server priority value based at least one factor selected from information about a user of the one or more virtual machines of a server, a workload of the one or more virtual machines of the server, a number of the one or more virtual machines on the server, a tenancy type of the server group of the server, and a server type of the server.

16. The computing device of claim 15, wherein the server priority value is generated based a plurality of factors including information about the user, the information being an importance score of the user, and the importance score being weighted more than any remaining factor used.

17. The computing device of claim 11, wherein the execution of the program instructions by the processor further configures the computing device to perform operations comprising automatically allocating the standby server of the at least one pool of standby servers responsive to performing a viability action to compute a viability of the standby server to replace the failed server.

18. A computer program product for managing servers, the computer program product comprising:
one or more computer-readable storage devices and program instructions stored on the at least one of the one or more computer-readable storage devices, the program instructions executable by a processor, the program instructions comprising:
program instructions to obtain a configuration of a plurality of server groups, the configuration including information about virtual machines on servers of the server groups, and the plurality of server groups including at least one pool of standby servers that is at least operatively distinct from a rest of the plurality of server groups;
program instructions to detect a failure event of a failed server;
program instructions to automatically allocate, responsive to the detecting, a standby server of the at least one pool of standby servers to a server group of the failed server based on at least one priority value selected from the group consisting of a server priority value of the failed server and a virtual machine priority value of one or more virtual machines of the failed server; and
program instructions to remotely restart the one or more virtual machines of the failed server on the standby server.

19. The computer program product of claim 18, wherein the program instructions further comprise:
programs instructions to assign to each of the one or more virtual machines of servers of the server groups, the virtual machine priority value prior to the detecting; and
programs instructions to assign to each of the servers of the server groups, the server priority value prior to the detecting.

20. The computer program product of claim 18, wherein the program instructions further comprise programs instructions to generate the server priority value based at least one factor selected from information about a user of the one or more virtual machines of a server, a workload of the one or more virtual machines of the server, a number of the one or more virtual machines on the server, a tenancy type of the server group of the server, and a server type of the server.
